(19) United States
(12) Patent Application Publication
(10) Pub. No.: US 2026/0246257 A1
(43) Pub. Date: Aug. 20, 2026

(54) HIGH-VOLTAGE CABLE SPLICING CIRCUIT WITH SELECTIVE ISOLATION IN A GAS COMPARTMENT AND RELATED METHOD

(71) Applicant: Mitsubishi Electric Power Products, Inc., Warrendale, PA (US)

(72) Inventors: Ashley Maria ZAGARI, Warrendale, PA (US); Brenda WAGAR, Warrendale, PA (US)

(21) Appl. No.: 19/058,409

(22) Filed: Feb. 20, 2025

(51) Int. Cl. H02G 15/24

(52) U.S. Cl. CPC H02G 15/24

(57) ABSTRACT

A device may include a gas compartment, a first cable termination connected to the gas compartment, a second cable termination connected to the gas compartment, a third cable termination connected to the gas compartment, an electrical connection located in the gas compartment and electrically connecting the first, second, and third cable terminations together, a first isolation circuit located between the first cable termination and the electrical connection, and a second isolation circuit located between the second cable termination and the electrical connection. The first isolation circuit is configured to selectively connect the first cable termination to the electrical connection and disconnect the first cable termination from the electrical connection. The second isolation circuit is configured to selectively connect the second cable termination to the electrical connection and disconnect the second cable termination from the electrical connection. The electrical connection does not directly contact a wall of the gas compartment.

### TECHNICAL FIELD

The disclosed systems and methods relate generally to a system and method for splicing high-voltage cables that allows selective isolation. Specifically, the disclosed systems relate to a circuit and method that allows multiple cables to be spliced together in a gas compartment such that individual cables can be electrically isolated from the splice.

### BACKGROUND

Traditional high-voltage cable splicing techniques have often relied on mechanical connectors and insulating tapes to join cable ends. These methods typically involve stripping the cable ends, aligning them, and securing them with a connector, followed by wrapping the joint with insulating tape to prevent electrical leakage. While these methods are straightforward, they can be labor-intensive and may not provide the necessary reliability and safety for high-voltage applications, especially in environments where moisture or other contaminants are present.

Another approach has been the use of heat-shrinkable tubing and resin-filled splice kits. These kits provide a more robust insulation by encasing the splice in a protective layer that is resistant to environmental factors. The heat-shrinkable tubing is applied over the splice and then heated to form a tight seal, while resin-filled kits involve pouring a liquid resin into a mold around the splice, which then hardens to form a protective barrier. Although these methods offer improved protection compared to traditional tape, they can be cumbersome to apply and may require specialized equipment or training.

Gas-insulated splicing techniques have also been developed, where the splice is enclosed in a compartment filled with an insulating gas, such as sulfur hexafluoride (SF₆). This method provides excellent insulation and is particularly effective in high-voltage applications. However, the complexity of ensuring a gas-tight seal and the potential environmental impact of the insulating gases used have posed challenges. Additionally, these systems often lack the flexibility to easily isolate and reconnect individual cable terminations without significant disassembly. Furthermore, these systems generally require an entire spliced system to be shut down to allow a single cable to be removed or worked on.

However, none of these approaches have provided a comprehensive solution that combines the features described in this disclosure.

### SUMMARY OF THE INVENTION

In some aspects, the techniques described herein relate to a high-voltage cable splicing circuit, including: a gas compartment; a first cable termination connected to the gas compartment; a second cable termination connected to the gas compartment; a third cable termination connected to the gas compartment; an electrical connection located in the gas compartment and electrically connecting the first, second, and third cable terminations together; a first isolation circuit located between the first cable termination and the electrical connection, the first isolation circuit being configured to selectively connect the first cable termination to the electrical connection and disconnect the first cable termination from the electrical connection; and a second isolation circuit located between the second cable termination and the electrical connection, the second isolation circuit being configured to selectively connect the second cable termination to the electrical connection and disconnect the second cable termination from the electrical connection; wherein the electrical connection does not directly contact a wall of the gas compartment.

In some aspects, the techniques described herein relate to a high-voltage cable splicing circuit, wherein the gas compartment is filled with an insulating gas.

In some aspects, the techniques described herein relate to a high-voltage cable splicing circuit, wherein the insulating gas is SF₆.

In some aspects, the techniques described herein relate to a high-voltage cable splicing circuit, wherein the first and second isolating circuits are first and second switches, respectively.

In some aspects, the techniques described herein relate to a high-voltage cable splicing circuit, wherein the first and second switches are mechanically controlled switches.

In some aspects, the techniques described herein relate to a high-voltage cable splicing circuit, wherein the first and second switches are electrically controlled switches.

In some aspects, the techniques described herein relate to a high-voltage cable splicing circuit, wherein the first isolation circuit includes a first removable link, the second isolation circuit includes a second removable link, the first isolation circuit is configured such that when the first removable link is inserted within the first isolation circuit the first cable termination is connected to the electrical connection, and when the first removable link is removed from the first isolation circuit the first cable termination is disconnected from the electrical connection, and the second isolation circuit is configured such that when the second removable link is inserted within the second isolation circuit the second cable termination is connected to the electrical connection, and when the second removable link is removed from the second isolation circuit the second cable termination is disconnected from the electrical connection.

In some aspects, the first and second removable links can be first and second removable draw leads.

In some aspects, the techniques described herein relate to a high-voltage cable splicing circuit, further including: a third isolation circuit located between the third cable termination and the electrical connection, the third isolation circuit being configured to selectively connect the third cable termination to the electrical connection and disconnect the third cable termination from the electrical connection.

In some aspects, the techniques described herein relate to a high-voltage cable splicing circuit, wherein the third isolating circuit is a third switch.

In some aspects, the techniques described herein relate to a high-voltage cable splicing circuit, wherein the third isolation circuit includes a third removable link, and the third isolation circuit is configured such that when the third removable link is inserted within the third isolation circuit the third cable termination is connected to the electrical connection, and when the third removable link is removed from the third isolation circuit the third cable termination is disconnected from the electrical connection.

In some aspects, the techniques described herein relate to a high-voltage cable splicing circuit, further including: a plurality of electrical connection insulators configured to insulate the electrical connection from the wall of the gas compartment and prevent the electrical connection from contacting the wall of the gas compartment.

In some aspects, the techniques described herein relate to a high-voltage cable splicing circuit, further including: a first corona shield connected between the first cable termination and the first isolation circuit, the first corona shield being configured to prevent a corona discharge at the first cable termination, a second corona shield connected between the second cable termination and the second isolation circuit, the second corona shield being configured to prevent a corona discharge at the second cable termination, and a third corona shield connected between the third cable termination and the third isolation circuit, the third corona shield being configured to prevent a corona discharge at the third cable termination.

In some aspects, the techniques described herein relate to a high-voltage cable splicing circuit, wherein a first high-voltage electric cable is connected to the first cable termination, a second high-voltage electric cable is connected to the second cable termination, and a third high-voltage electrical cable is connected to the third cable termination.

In some aspects, the techniques described herein relate to a high-voltage cable splicing circuit, wherein the gas compartment includes one or more pipes.

In some aspects, the techniques described herein relate to a high-voltage cable splicing circuit, further including: an access port formed in the wall of the gas compartment and configured to allow access to the interior of the gas compartment.

In some aspects, the techniques described herein relate to a high-voltage cable splicing circuit, wherein the electrical connection includes a high-voltage cable having three terminals that are electrically connected to each other within the electrical connection.

In some aspects, the techniques described herein relate to a high-voltage cable splicing circuit, wherein the gas compartment further includes a central gas compartment; a first gas compartment connected between the central gas compartment and the first cable termination; a second gas compartment connected between the central gas compartment and the second cable termination; a third gas compartment connected between the central gas compartment and the third cable termination; a first gas barrier formed between the central gas compartment and the first gas compartment; a second gas barrier formed between the central gas compartment and the second gas compartment; and a third gas barrier formed between the central gas compartment and the third gas compartment.

In some aspects, the techniques described herein relate to a high-voltage cable splicing circuit, wherein the first isolation circuit is formed in the first gas compartment, the second isolation circuit is formed in the second gas compartment, and the third isolation circuit is formed in the third gas compartment.

In some aspects, the techniques described herein relate to a high-voltage cable splicing circuit, including: first, second, third, fourth, fifth, sixth, seventh, eighth, and ninth cable chambers; first, second, and third cable splicing chambers; wherein the first cable splicing chamber is connected between the first cable chamber, the fourth cable chamber, and the seventh cable chamber, the second cable splicing chamber is connected between the second cable chamber, the fifth cable chamber, and the eighth cable chamber, the third cable splicing chamber is connected between the third cable chamber, the sixth cable chamber, and the ninth cable chamber, and the first cable splicing chamber includes a first electrical connection; a first isolation circuit connected between the first electrical connection and the first cable chamber; a fourth isolation circuit connected between the first electrical connection and the fourth cable chamber; and a seventh isolation circuit connected between the first electrical connection and the seventh cable chamber.

In some aspects, the techniques described herein relate to a high-voltage cable splicing circuit, wherein each of the first, second, third, fourth, fifth, sixth, seventh, eighth, and ninth cable chambers and each of the first, second, and third cables splicing chambers is filled with an insulating gas.

In some aspects, the techniques described herein relate to a high-voltage cable splicing circuit, wherein the insulating gas is SF₆.

In some aspects, the techniques described herein relate to a high-voltage cable splicing circuit, wherein the first, second, third, fourth, fifth, sixth, seventh, eighth, and ninth cable chambers contain first, second, third, fourth, fifth, sixth, seventh, eighth, and ninth high-voltage electrical cables, respectively.

In some aspects, the techniques described herein relate to a high-voltage cable splicing circuit, wherein the second cable splicing chamber includes a second electrical connection; a second isolation circuit connected between the second electrical connection and the second cable chamber; a fifth isolation circuit connected between the second electrical connection and the fifth cable chamber; and an eighth isolation circuit connected between the second electrical connection and the eighth cable chamber.

In some aspects, the techniques described herein relate to a high-voltage cable splicing circuit, wherein the third cable splicing chamber includes a third electrical connection; a third isolation circuit connected between the third electrical connection and the third cable chamber; a sixth isolation circuit connected between the third electrical connection and the sixth cable chamber; and a ninth isolation circuit connected between the third electrical connection and the ninth cable chamber.

In some aspects, the techniques described herein relate to a method of isolating a spliced high-voltage cable, including: placing a high-voltage electrical connection in a gas compartment; filling the gas compartment with an insulating gas; electrically connecting a first high-voltage cable to a first terminal of the high-voltage electrical connection such that a first isolation circuit is arranged between the first high-voltage cable and the high-voltage electrical connection; setting the first isolation circuit to a conducting orientation in which current is allowed to pass between the first high-voltage cable and the high-voltage electrical connection; electrically connecting a second high-voltage cable to a second terminal of the high-voltage electrical connection; electrically connecting a third high-voltage cable to a third terminal of the electrical connection; passing a first electric current between the first high-voltage cable and the high-voltage electrical connection; after passing the first electric current between the first high-voltage cable and the high-voltage electrical connection, setting the first isolation circuit to a non-conducting orientation in which current is prevented from flowing between the first cable and the electrical connection; and removing the first high-voltage cable from the first terminal of the high-voltage electrical connection.

In some aspects, the techniques described herein relate to a method, wherein the insulating gas is SF₆.

In some aspects, the techniques described herein relate to a method, wherein the operation of setting the first isolation circuit to the conducting orientation includes placing a first link between the first high-voltage cable and the high-voltage electrical connection, and the operation of setting the first isolation circuit to the non-conducting orientation includes removing the first link from between the first high-voltage cable and the high-voltage electrical connection.

In some aspects, the techniques described herein relate to a method, wherein the operation of setting the first isolation circuit to the conducting orientation includes causing a first switch located between the first high-voltage cable and the high-voltage electrical connection to be placed in a closed position that allows current to flow through the first switch, and the operation of setting the first isolation circuit to the non-conducting orientation includes causing the first switch to be placed in an open position that prevents current from flowing through the first switch.

In some aspects, the techniques described herein relate to a method, wherein the operation of electrically connecting the second high-voltage cable to the second terminal of the high-voltage electrical connection is performed such that a second isolation circuit is arranged between the second high-voltage cable and the high-voltage electrical connection.

In some aspects, the techniques described herein relate to a method, wherein the operation of electrically connecting the third high-voltage cable to the third terminal of the high-voltage electrical connection is performed such that a third isolation circuit is arranged between the third high-voltage cable and the high-voltage electrical connection.

In some aspects, the techniques described herein relate to a method, further including: passing a second electric current from the second high-voltage cable to the high-voltage electrical connection; after passing the second electric current from the second high-voltage cable to the high-voltage electrical connection, setting the second isolation circuit to an open position in which current is prevented from flowing between the second high-voltage cable and the high-voltage electrical connection; and removing the second high-voltage cable from the second terminal of the high-voltage electrical connection.

In some aspects, the techniques described herein relate to a method, wherein the operation of setting the second isolation circuit to the conducting orientation includes placing a second link between the second high-voltage cable and the high-voltage electrical connection, and the operation of setting the second isolation circuit to the non-conducting orientation includes removing the second link from between the second cable and the high-voltage electrical connection.

In some aspects, the techniques described herein relate to a method, wherein the operation of setting the second isolation circuit to the conducting orientation includes causing a second switch located between the second high-voltage cable and the high-voltage electrical connection to be placed in a closed position that allows current to flow through the second switch, and the operation of setting the second isolation circuit to the non-conducting orientation includes causing the second switch to be placed in an open position that prevents current from flowing through the second switch.

### BRIEF DESCRIPTION OF THE DRAWINGS

The accompanying figures, where like reference numerals refer to identical or functionally similar elements and which together with the detailed description below are incorporated in and form part of the specification, serve to further illustrate an exemplary embodiment and to explain various principles and advantages in accordance with the present disclosure.

FIG. 1 is electrical configuration diagram of a high-voltage cable splicing circuit according to an exemplary device;

FIG. 2 is a cross-sectional view of a high-voltage cable splicing circuit using removable links as isolation circuits according to an exemplary device;

FIG. 3 is a cross-sectional view of a high-voltage cable splicing circuit using removable links as isolation circuits according to another exemplary device;

FIG. 4 is a cross-sectional view of a high-voltage cable splicing circuit using switches as isolation circuits according to an exemplary device;

FIG. 5 is an overhead view of a three-phase, high-voltage cable splicing circuit according to an exemplary device;

FIG. 6 is a perspective view of the three-phase, high-voltage cable splicing circuit from FIG. 5 according to an exemplary device;

FIG. 7 is a flowchart of a method of operating a high-voltage cable splicing circuit according to exemplary methods.

### DETAILED DESCRIPTION

The instant disclosure is provided to further explain in an enabling fashion the best modes of performing one or more embodiments of the present invention. The disclosure is further offered to enhance an understanding and appreciation for the inventive principles and advantages thereof, rather than to limit in any manner the invention. The invention is defined solely by the appended claims including any amendments made during the pendency of this application and all equivalents of those claims as issued.

It is further understood that the use of relational terms such as first and second, and the like, if any, are used solely to distinguish one from another entity, item, or action without necessarily requiring or implying any actual such relationship or order between such entities, items or actions. It is noted that some embodiments may include a plurality of processes or steps, which can be performed in any order, unless expressly and necessarily limited to a particular order; i.e., processes or steps that are not so limited may be performed in any order.

### High-Voltage Cable Splicing Circuit

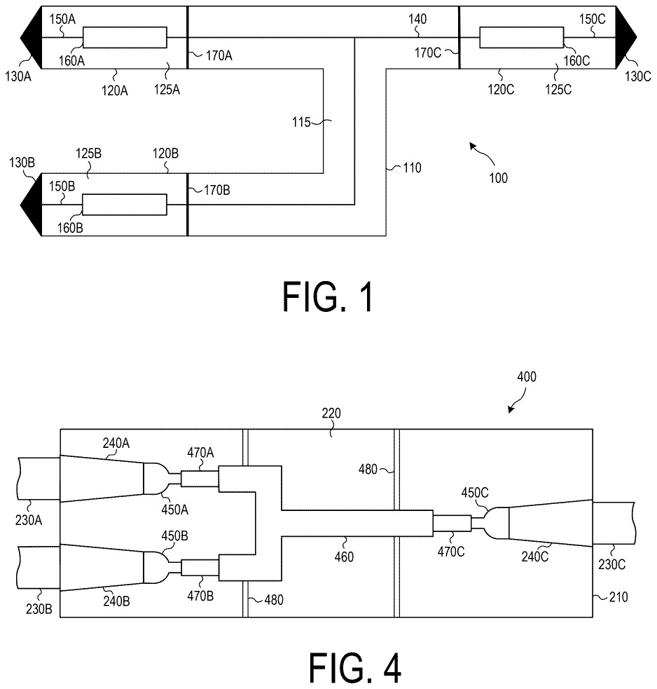

FIG. 1 is an electrical configuration diagram of a high-voltage cable splicing circuit 100 according to an exemplary device. As shown in FIG. 1, the high-voltage cable splicing circuit 100 includes a central gas compartment 110, first, second, and third connecting gas compartments 120A, 120B, 120C (referred to generally as connecting gas compartments 120), first, second, and third cable terminations 130A, 130B, 130C (referred to generally as cable terminations 130), a central electrical connection 140, first, second, and third high-voltage electrical connections 150A, 150B, 150C (referred to generally as high-voltage electrical connections 150), first, second, and third isolation circuits 160A, 160B, 160C (referred to generally as isolation circuits 160), and first, second, and third gas barriers 170A, 170B, 170C (referred to generally as gas barriers 170). The first, second, and third connecting gas compartments 120A, 120B, 120C defined first, second, and third connecting interior chambers 125A, 125B, 125C, respectively (referred to generally as connecting interior chambers 125).

The central gas compartment 110 defines a central interior chamber 115 that contains the central electrical connection 140 and is configured such that it can be filled with an insulating gas.

The first gas compartment 120A is connected between the central gas compartment 110 and the first cable termination 130A. The first gas compartment 120A defines the first connecting interior chamber 125A that contains the first high-voltage electrical connection 150A and is configured such that it can be filled with the insulating gas.

The second gas compartment 120B is connected between the central gas compartment 110 and the second cable termination 130B. The second gas compartment 120B defines the second connecting interior chamber 125B that contains the second high-voltage electrical connection 150B and is configured such that it can be filled with the insulating gas.

The third gas compartment 120C is connected between the central gas compartment 110 and the third cable termination 130C. The third gas compartment 120C defines the third connecting interior chamber 125C that contains the third high-voltage electrical connection 150C and is configured such that it can be filled with the insulating gas.

The various interior chambers 115, 125 are configured to be airtight such that when they are filled with the insulating gas, the insulating gas cannot escape from the respective interior chamber 115, 125.

The first cable termination 130A is connected to the first gas compartment 120A and facilitates the connection of a first high-voltage cable (not shown in FIG. 1) to the first high-voltage electrical connection 150A.

The second cable termination 130B is connected to the second gas compartment 120B and facilitates the connection of a second high-voltage cable (not shown in FIG. 1) to the second high-voltage electrical connection 150B.

The third cable termination 130C is connected to the third gas compartment 120C and facilitates the connection of a third high-voltage cable (not shown in FIG. 1) to the third high-voltage electrical connection 150C.

The central electrical connection 140 is a three-way high-voltage conductor (e.g., a cable) that is electrically connected to the first, second, and third high-voltage electrical connections 150. It operates to pass high-voltage current between the first, second, and third-voltage electrical connections 150.

The first high-voltage electrical connection 150A is a high-voltage electric conductor (e.g., a cable) connected between the first cable termination 130A and the central electrical connection 140. It operates to pass high-voltage current between the first cable termination 130A (and the high-voltage cable connected to the first cable termination 130A) and the central electrical connection 140.

The second high-voltage electrical connection 150B is a high-voltage electric conductor (e.g., a cable) connected between the second cable termination 130B and the central electrical connection 140. It operates to pass high-voltage current between the second cable termination 130B (and the high-voltage cable connected to the second cable termination 130B) and the central electrical connection 140.

The third high-voltage electrical connection 150C is a high-voltage electric conductor (e.g., a cable) connected between the third cable termination 130C and the central electrical connection 140. It operates to pass high-voltage current between the third cable termination 130C (and the high-voltage cable connected to the third cable termination 130C) and the central electrical connection 140.

The first isolation circuit 160A is located in the first high-voltage electrical connection 150A and is configured to selectively electrically isolate the first cable termination 130A from the central electrical connection 140. In various exemplary devices the first isolation circuit 160A may be a removable link (such as a removable draw lead), an electrically controlled switch, a mechanically controlled switch, or any suitable circuit that can operate to selectively electrically isolate two inputs.

The second isolation circuit 160B is located in the second high-voltage electrical connection 150B and is configured to selectively electrically isolate the second cable termination 130B from the central electrical connection 140. In various exemplary devices the second isolation circuit 160B may be a removable link (such as a removable draw lead), an electrically controlled switch, a mechanically controlled switch, or any suitable circuit that can operate to selectively electrically isolate two inputs.

The third isolation circuit 160C is located in the third high-voltage electrical connection 150C and is configured to selectively electrically isolate the third cable termination 130C from the central electrical connection 140. In various exemplary devices the third isolation circuit 160C may be a removable link (such as a removable draw lead), an electrically controlled switch, a mechanically controlled switch, or any suitable circuit that can operate to selectively electrically isolate two inputs.

In some exemplary devices the isolation circuits 160 will all be implemented in the same manner. However alternate exemplary devices could use different types of isolation circuits 160 in each of the high-voltage electrical connections 150. For example, in one exemplary device the first and second isolation circuits 160A, 160B could be implemented as removable links (such as a removable draw leads), while the third isolation circuit 160C could be implemented as a mechanically controlled switch. Various other combinations are possible.

The first gas barrier 170A is located between the central gas compartment 110 and the first connecting gas compartment 120A. It serves to restrict the movement of gas between the central interior chamber 115 and the first connecting interior chamber 125A and maintain the pressure of the gas in each interior chamber 115, 125. In various exemplary devices it can be implemented in a variety of ways. For example, in a device in which the central gas compartment 110 and the first connecting gas compartment 120A are pipes, the first gas barrier 170A can be a non-conductive disk with an outside radius equal to the inside radius of the central gas compartment 110/first connecting gas compartment 120A and a hole to accommodate the central electrical connection 140/first high-voltage electrical connection 150A. In such an implementation, the first gas barrier 170A blocks an area between the central electrical connection 140/first high-voltage electrical connection 150A and the inside of the central gas compartment 110/first connecting gas compartment 120A such that gas cannot pass between the central gas compartment 110 in the first connecting gas compartment 120A.

The second gas barrier 170B is located between the central gas compartment 110 and the second connecting gas compartment 120B. It serves to restrict the movement of gas between the central interior chamber 115 and the second connecting interior chamber 125B. In various exemplary devices it can be implemented in a variety of ways. For example, in a device in which the central gas compartment 110 and the second connecting gas compartment 120B are pipes, the second gas barrier 170B can be a non-conductive disk with an outside radius equal to the inside radius of the central gas compartment 110/second connecting gas compartment 120B and a hole to accommodate the central electrical connection 140/second high-voltage electrical connection 150B. In such an implementation, the second gas barrier 170B blocks an area between the central electrical connection 140/second high-voltage electrical connection 150B and the inside of the central gas compartment 110/second connecting gas compartment 120B such that gas cannot pass between the central gas compartment 110 in the second connecting gas compartment 120B.

The third gas barrier 170C is located between the central gas compartment 110 and the third connecting gas compartment 120C. It serves to restrict the movement of gas between the central interior chamber 115 and the third connecting interior chamber 125C. In various exemplary devices it can be implemented in a variety of ways. For example, in a device in which the central gas compartment 110 and the third connecting gas compartment 120C are pipes, the third gas barrier 170C can be a non-conductive disk with an outside radius equal to the inside radius of the central gas compartment 110/third connecting gas compartment 120C and a hole to accommodate the central electrical connection 140/third high-voltage electrical connection 150C. In such an implementation, the third gas barrier 170C blocks an area between the central electrical connection 140/third high-voltage electrical connection 150C and the inside of the central gas compartment 110/third connecting gas compartment 120C such that gas cannot pass between the central gas compartment 110 in the third connecting gas compartment 120C.

By having the gas barriers 170 breaking up the various interior chambers 115, 125, the structure allows for an individual chamber 115, 125 to be opened without interfering with the gas contained in all the other chambers 115, 125.

In some exemplary devices the gas barriers 170 will all be implemented in the same manner. However alternate embodiments could use different types of gas barriers 170 between the central gas compartment 110 and each of the connecting gas compartments 120.

The disclosed cable splicing circuit 100 can be used in a variety of situations. For example, one such device might be used to connect to incoming high-voltage cable to a single high-voltage cable in a transformer. Another exemplary device might connect multiple incoming high-voltage cable to a single high-voltage cable in a power plant. Yet other exemplary devices might connect multiple interior cables to a single outgoing cable in similar environments.

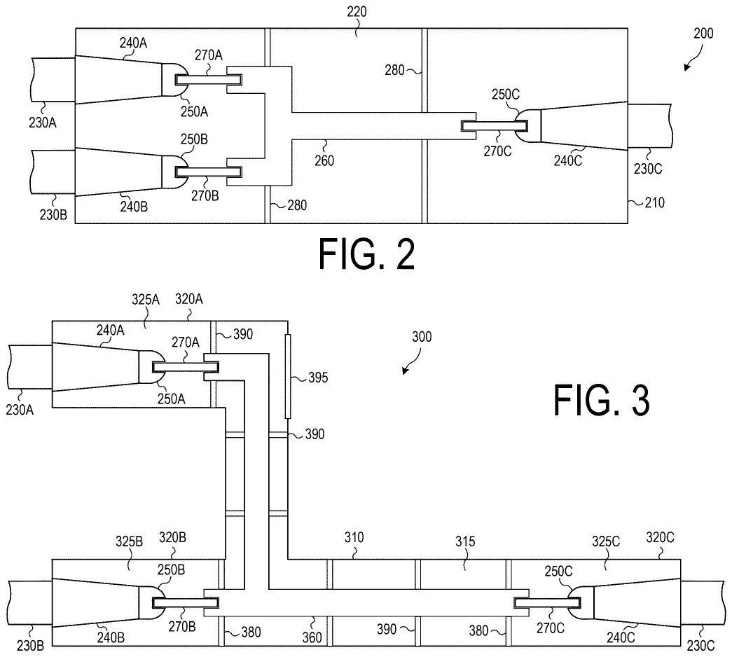

FIG. 2 is a cross-sectional view of a high-voltage cable splicing circuit 200 using removable links 270 as isolation circuits according to an exemplary device. In this exemplary device, the cable splicing circuit 200 uses an airtight container as a gas compartment.

As shown in FIG. 2, the high-voltage cable splicing circuit 200 includes a gas compartment 210, first, second, and third high-voltage cables 230A, 230B, 230C (generally referred to as high-voltage cable 230), first, second, and third cable termination ends 240A, 240B, 240C (generally referred to as cable termination ends 240), first, second, and third cable connectors 250A, 250B, 250C (generally referred to as cable connectors 250), a high-voltage electrical connection 260, first, second, and third removable links 270A, 270B, 270C (generally referred to as removable links 270), and a plurality of electrical connection insulators 280. The gas compartment 210 defines an interior chamber 220, which is configured such that it can be filled with an insulating gas.

The gas compartment 210 is an airtight container properly configured to contain a high-voltage cable. In various exemplary devices it could be a pipe, a box, or suitable structure for containing the components described below.

The interior chamber 220 is configured to contain an insulating gas that electrically insulate the high-voltage electrical connection 260 from the wall of the central gas compartment 210.

The first, second, and third high-voltage cables 230A, 230B, 230C are high-voltage cables that electrically connect to respective first, second, and third cable connectors 250A, 250B, 250C such that power can flow from respective high-voltage cable 230 to its corresponding cable connector 250. Although FIG. 2 appears to show respective cable termination ends 240 as being between corresponding high-voltage cable 230 and cable connectors 250, the high-voltage cable 230 each connect directly to a corresponding cable connector 250. In various exemplary devices, each high-voltage cable 230 may extend partially into the interior chamber 220. For example, in some exemplary devices, a male/female plug assembly can be provided between the cables 230 and the cable connectors 250 with a male plug attached to one of the cable 230 and the cable connector 250 and the female plug attached to the other of the cable 230 and the cable connector 250.

The first, second, and third cable termination ends 240A, 240B, 240C are formed over the end of a corresponding high-voltage cable 230 where it connects to a corresponding cable connector 250 to seal exposed or frayed cable lengths and to protect them from environmental damage, moisture, dirt, etc. In various exemplary devices, the cable termination ends 240 can be made of PVC, polyolefin, or any other suitable material. This may include covering any plug assembly between a corresponding cable 230 and cable connector 250.

The first, second, and third cable connectors 250A, 250B, 250C are each electrically connected to a corresponding high-voltage cable 230. The cable connectors are also each electrically connected to a corresponding removable link 270 such that high-voltage current can pass from the high-voltage cable 230 to the high-voltage electrical connection 260 via a corresponding cable connector 250 and removable link 270.

The first cable connector 250A may include a first corona shield configured to prevent a corona discharge at a first cable termination of the first high-voltage cable 230A. The second cable connector 250B may include a second corona shield configured to prevent a corona discharge at a second cable termination of the second high-voltage cable 230B. The third cable connector 250C may include a third corona shield configured to prevent a corona discharge at a third cable termination of the third high-voltage cable 230C.

The electrical connection 260 is a three-way high-voltage cable that is electrically connected to the high-voltage cables 230 via respective cable connectors 250 and removable links 270. It operates to pass high-voltage current between the first, second, and third high-voltage electrical cables 230 via the cable connectors 250 and the removable links 270.

The first, second, and third removable links 270A, 270B, 270C are each a high-voltage cable or solid conductor configured to pass high-voltage current (e.g., a draw lead). Each removable link 270 is configured to be selectively removed from or inserted between a corresponding cable connector 250 and the electrical connection 260. When a removable link 270 is connected, it is in a conductive orientation that allows the high-voltage current to pass between the corresponding cable connector 250 and the electrical connection 260. When the removable link 270 is disconnected, it is in a non-conductive orientation that prevents the high-voltage current from passing between the corresponding cable connector 250 and the electrical connection 260.

However, when one of the first, second, or third removable links 270A, 270B, 270C is removed (i.e., placed in a non-conductive orientation) and the other of the first, second, or third removable links 270A, 270B, 270C is inserted (i.e., placed in a conductive orientation), high-voltage current can still pass between the high-voltage cables 230 connected to the corresponding removable links that are inserted. In this way, one high-voltage cable 230 can be disconnected from the cable splicing circuit 200 without interfering with the operation of the other high-voltage cables 230.

Furthermore, in exemplary devices in which more than three high-voltage cables are connected to the cable splicing circuit 200, multiple high-voltage cables can be disconnected without interfering with current flowing through the remaining high-voltage cables. In order to remove the draw leads, a short power outage is required on the corresponding high-voltage cable 230. Appropriate safety grounds and precautions are required to be in place prior to removing the insulating gas and opening the compartment to remove/reinstall the removable link.

The plurality of electrical connection insulators 280 are structures of an electrically insulating material that are formed between the electrical connection 260 and the walls of the gas compartment 210. The electrical connection insulators 280 provide structure to keep the electrical connection 260 physically and electrically separated from the walls of the gas compartment 210, thus preventing the electrical connection 260 from physically touching the walls of the gas compartment 210 and preventing current or sparks from passing between the electrical connection 260 and the walls of the gas compartment 210.

The electrical connection insulators 280 should be of sufficient strength to prevent undesirable movement of the electrical connection 260 and should be formed in a configuration that limits the movement of the electrical connection 260. While the electrical insulators 280 may allow some thermal movement and vibration, they should not allow sufficient movement of the electrical connection 260 to allow it to touch the walls of the gas compartment 210. The electrical insulators 280 should not restrict the movement of gas throughout the interior chamber 220. In some exemplary devices they could be implemented as a lattice of non-conductive supports. In other exemplary devices they could be implemented as solid plates connected to the interior walls of the gas compartment 210 that have at least a first hole configured to pass the electrical connection 260 and a second hole configured to allow the insulating gas to flow freely from one side of the electrical connection insulator 280 to the other. Other configurations for the electrical connection insulators 280 are possible.

The number and specific arrangement of the electrical connection insulators 280 can vary depending upon the strength of the electrical connection insulators 280 and the rigidness of the electrical connection 260. The number and arrangement of the electrical connection insulators 280 should be set to be sufficient to prevent the electrical connection 260 from touching the walls of the gas compartment 210.

In various exemplary devices, the electrical connection insulators 280 can be made out of epoxy, ceramic, or any other suitable insulating material. In various exemplary devices, the electrical connection insulators 280 can all be of a similar structure or multiple configurations of an electrical connection insulator 280 can be used in the same cable splicing circuit 200.

Although the exemplary device of FIG. 2 uses a single gas compartment 210 to contain all the electrical components of the cable splicing circuit 200, alternate exemplary devices could partition the interior chamber 220 into a plurality of interior chambers. In this way, individual components of the cable splicing circuit 200 could be accessed without having to evacuate all the gas from the entire interior chamber 220.

FIG. 3 is a cross-sectional view of a high-voltage cable splicing circuit 300 using removable links 370 as isolation circuits according to another exemplary device. In this exemplary device, the cable splicing circuit 300 uses pipes as gas compartments.

As shown in FIG. 3, the high-voltage cable splicing circuit 300 includes a central gas compartment 310, first, second, and third connecting gas compartments 320A, 320B, 320C, first, second, and third high-voltage cables 230A, 230B, 230C, first, second, and third cable termination ends 240A, 240B, 240C, first, second, and third cable connectors 250A, 250B, 250C, a high-voltage electrical connection 360, first, second, and third removable links 270A, 270B, 270C, a plurality of electrical connection insulators 380, and first, second, and third gas barriers 390A, 390B, and 390C (generally referred to as gas barriers 390). The central gas compartment 310 defines a central interior chamber 320, which is configured such that it can be filled with insulating gas. The first, second, and third connecting gas compartments 320A, 320B, 320C each define first, second, and third connecting interior chambers 325A, 325B, 325C, respectively.

The high-voltage cables 230, the cable termination ends 240, the cable connectors 250, and the removable links 270 operate as described above with respect to the exemplary device of FIG. 2. Their description will not be repeated here for the sake of brevity.

The central gas compartment 310 is an airtight container configured to contain the electrical connection 360. In the exemplary device of FIG. 3, the central gas compartment 310 is a pipe of the sort used in high-voltage environments.

The central interior chamber 315 is configured to contain an insulating gas that electrically insulates the high-voltage electrical connection 360 from the wall of the central gas compartment 310.

The connecting gas compartments 320 are each an airtight container configured to contain a respective cable cap 240, cable connector 250, and removable link 270. In some exemplary devices, a portion of the electrical connection 360 may also extend into a respective connecting gas compartment 320. In the exemplary device of FIG. 3, the connecting gas compartment 320 is a pipe of the sort used in high-voltage environments.

The connecting interior chambers 325 are each configured to contain an insulating gas that electrically insulates the respective high-voltage cable 230, cable connector 250, and removable link 270 from a wall of the respective connecting gas compartment 320.

The electrical connection 360 is a three-way high-voltage cable that is electrically connected to the high-voltage cables 230 via respective cable connectors 250 and removable links 270. It operates to pass high-voltage current between the first, second, and third high-voltage electrical cables 230.

The plurality of electrical connection insulators 380 are structures of an electrically insulating material that are formed between the electrical connection 360 and the walls of the central gas compartment 310. The electrical connection insulators 380 provide structure to keep the electrical connection 360 physically and electrically separated from the walls of the central gas compartment 310, thus preventing the electrical connection 360 from physically touching the walls of the central gas compartment 310 and preventing current or sparks from passing between the electrical connection 360 and the walls of the central gas compartment 310.

The electrical connection insulators 380 should be of sufficient strength to prevent undesirable movement of the electrical connection 360 and should be formed in a configuration that limits the movement of the electrical connection 360. While the electrical insulators 380 may allow some thermal movement and vibration, they should not allow sufficient movement of the electrical connection 360 to allow it to touch the walls of the central gas compartment 310. However, they should not restrict the movement of gas throughout the center interior chamber 315. In some exemplary devices they could be implemented as a lattice of non-conductive supports. In other exemplary devices they could be implemented as solid plates connected to the interior walls of the central gas compartment 310 that have at least a first hole configured to pass the electrical connection 360 and a second hole configured to allow the insulating gas to flow freely from one side of the electrical connection insulator 380 to the other. Other configurations for the electrical connection insulators 380 are possible.

The number and specific arrangement of the electrical connection insulators 380 can vary depending upon the strength of the electrical connection insulators 380 and the rigidness of the electrical connection 360. The number and arrangement of the electrical connection insulators 380 should be set to be sufficient to prevent the electrical connection 360 from touching the walls of the central gas compartment 310.

In addition, although no similar insulators are provided in the connecting gas compartments 320, alternate embodiments could provide comparable insulators to prevent the high-voltage cables 230 or the cable connectors 250 from contacting the walls of the corresponding connecting gas compartment 320 or from conducting current between the high-voltage cables 230 cable connectors 250 and the walls of the corresponding connecting gas compartment 320.

The first gas barrier 390A is located between the central gas compartment 310 and the first connecting gas compartment 320A. It serves to restrict the movement of gas between the central interior chamber 315 and the first connecting interior chamber 325A. In various exemplary devices it can be implemented in a variety of ways. In the exemplary device of FIG. 3, the first gas barrier 390A is a non-conductive disk that seals the space between the central gas compartment 310 and a first connecting gas compartment 320A. In one exemplary device the first gas barrier 390A may have an outside radius equal to the inside radius of the central gas compartment 310/first connecting gas compartment 320A and a hole to accommodate the central electrical connection 360. In this case, the central gas compartment 310 and the first connecting gas compartment 320A are connected to each other and the first gas barrier 390A is formed inside the two proximate to where they meet. In another exemplary device, the first gas barrier 390A may have an outer radius equal to the outer radius of the central gas compartment 310/first connecting gas compartment 320A and a hole to accommodate the central electrical connection 360. In this exemplary case, the first gas barrier 390A is formed between the central gas compartment 310 and the first connecting gas compartment 320A. In both exemplary devices, the first gas barrier 390A blocks an area between the central electrical connection 360 and the inside of the central gas compartment 310/first connecting gas compartment 320A such that gas cannot pass between the central gas compartment 310 in the first connecting gas compartment 320A.

The second gas barrier 390B is located between the central gas compartment 310 and the second connecting gas compartment 320B. In one exemplary device the second gas barrier 390B may have an outside radius equal to the inside radius of the central gas compartment 310/second connecting gas compartment 320B and a hole to accommodate the central electrical connection 360. In this case, the central gas compartment 310 and the second connecting gas compartment 320B are connected to each other and the second gas barrier 390B is formed inside the two proximate to where they meet. In another exemplary device, the second gas barrier 390B may have an outer radius equal to the outer radius of the central gas compartment 310/second connecting gas compartment 320B and a hole to accommodate the central electrical connection 360. In this exemplary case, the second gas barrier 390B is formed between the central gas compartment 310 and the second connecting gas compartment 320B. In both exemplary devices, the second gas barrier 390B blocks an area between the central electrical connection 360 and the inside of the central gas compartment 310/second connecting gas compartment 320B such that gas cannot pass between the central gas compartment 310 in the second connecting gas compartment 320B.

The third gas barrier 390C is located between the central gas compartment 310 and the third connecting gas compartment 320C. In one exemplary device the third gas barrier 390C may have an outside radius equal to the inside radius of the central gas compartment 310/third connecting gas compartment 320C and a hole to accommodate the central electrical connection 360. In this case, the central gas compartment 310 and the third connecting gas compartment 320C are connected to each other and the third gas barrier 390C is formed inside the two proximate to where they meet. In another exemplary device, the third gas barrier 390C may have an outer radius equal to the outer radius of the central gas compartment 310/third connecting gas compartment 320C and a hole to accommodate the central electrical connection 360. In this exemplary case, the third gas barrier 390C is formed between the central gas compartment 310 and the third connecting gas compartment 320C. In both exemplary devices, the third gas barrier 390C blocks an area between the central electrical connection 360 and the inside of the central gas compartment 310/third connecting gas compartment 320C such that gas cannot pass between the central gas compartment 310 in the third connecting gas compartment 320C.

By having the gas barriers 390 breaking up the various interior chambers 315, 325, this structure allows for an individual chamber 315, 325 to be opened without interfering with the gas contained in all the other chambers 315, 325.

In some exemplary devices, some or all of the electrical connection insulators 380 can be implemented by structures that are similar to the structures used for the gas barriers 390 with the exception that an opening is provided in the structure to allow gas to pass from one side to the other.

In addition, in some exemplary devices, the gas barriers 390 will all be implemented in the same manner. However alternate embodiments could use different types of gas barriers 390 between the central gas compartment 310 and each of the connecting gas compartments 320.

FIG. 4 is a cross-sectional view of a high-voltage cable splicing circuit 400 using switches 470 as isolation circuits according to an exemplary device. In this exemplary device, the cable splicing circuit 400 uses an airtight container as a gas compartment.

As shown in FIG. 4, the high-voltage cable splicing circuit 400 includes a gas compartment 210, first, second, and third high-voltage cables 230A, 230B, 230C, first, second, and third cable termination ends 240A, 240B, 240C, first, second, and third cable connectors 450A, 450B, 450C (generally referred to as cable connectors 450), a high-voltage electrical connection 460, first, second, and third switches 470A, 470B, 470C (generally referred to as switches 470), and a plurality of electrical connection insulators 480. The gas compartment 210 defines an interior chamber 220, which is configured such that it can be filled with insulating gas.

The gas compartment 210, high-voltage cables 230, and cable termination ends 240 operate as described above with respect to FIG. 2. Their description will not be repeated here for the sake of brevity.

The cable connectors 450 operate in a manner comparable to the cable connectors 250 described above with respect to FIG. 2, save that they are each electrically connected to a corresponding switch 470 rather than to a removable link.

The high-voltage electrical connection 460 operates in a manner comparable to the high-voltage electrical connection 260 described above with respect to FIG. 2 save that it is electrically connected to the switches 470 rather than to removable links.

The first, second, and third switches 470A, 470B, 470C are each an electrically controlled switch or a mechanically controlled switch configured to pass high-voltage current when closed. Each switch 270 is configured to be selectively placed in either an open position or a closed position. When a switch 270 is closed, it is in a conductive orientation that allows the high-voltage current to pass between the corresponding cable connector 450 and the electrical connection 460. When the switch 270 is open, it is in a non-conductive orientation that prevents the high-voltage current from passing between the corresponding cable connector 450 and the electrical connection 460. In various exemplary devices, the switches 470 may be ordinary switches or disconnect and grounding switches. A disconnect and grounding switch is a type of switch that opens the circuit and connects the conductor to ground. This allows for discharging the circuit and creating a safe environment for work.

However, when one of the first, second, or third switches 470A, 470B, 470C is open (i.e., placed in a non-conductive orientation) and the others of the first, second, or third switches 470A, 470B, 470C are closed (i.e., placed in a conductive orientation), high-voltage current can still pass between the high-voltage cables 230 connected to the corresponding switches 470 that are closed. In this way, one high-voltage cable 230 can be disconnected from the cable splicing circuit 400 without interfering with the operation of the other high-voltage cables 230.

Furthermore, in exemplary devices in which more than three high-voltage cables are connected to the cable splicing circuit 400, multiple high-voltage cables can be disconnected without interfering with current flowing through the remaining high-voltage cables.

The plurality of electrical connection insulators 480 operate in a manner comparable to the electrical connection insulators 280 of FIG. 2 except they are connected to the electrical connection 460 rather than the electrical connection 260.

Although the exemplary device of FIG. 4 uses a single gas compartment 410 to contain all the electrical components of the cable splicing circuit 400, alternate exemplary devices could partition the interior chamber 220 into a plurality of interior chambers. In this way, individual components of the cable splicing circuit 400 could be accessed without having to evacuate all the gas from the entire interior chamber 220.

Although the exemplary devices of FIGS. 1-4 all show a single implementation of two high-voltage cables being spliced to a third high-voltage cable, this is by way of example only. Other exemplary devices could vary the number of high-voltage cables on either side of the splice. For example, in other exemplary devices, three, four, or more cables could be spliced into a single cable or vice versa. Likewise multiple cables could be employed on either side of the splice. In each case, an isolation circuit may be provided for each connected high-voltage cable to allow it to be disconnected without interfering with the passage of current through the remainder of the high-voltage cable splicing circuit.

In addition, although the exemplary devices of FIGS. 1-4 all show an isolation circuit being provided for each high-voltage cable connected to the respective high-voltage cable splicing circuit, this is not required. Alternate exemplary devices could limit the isolation circuit to the connections for fewer than all the high-voltage cable connected to the high-voltage cable splicing circuit.

In various exemplary devices, the insulating gas may be sulfur hexafluoride (SF₆), which can serve as an effective electrical insulator for electrical connections contained inside various gas compartments in the cable splicing circuit 100. However, this is by way of example only. Other exemplary devices could use a different insulating gas that provides the desired level electrical insulation. For example, various fluorine-based gas mixtures, fluroketone-based gas mixtures, or dry air can be used as an insulating gas, though this list is not exhaustive. In some exemplary devices the insulating gas may be replaced with a vacuum to provide electrical insulation.

### Three-Phase, High-Voltage Cable Splicing Circuit

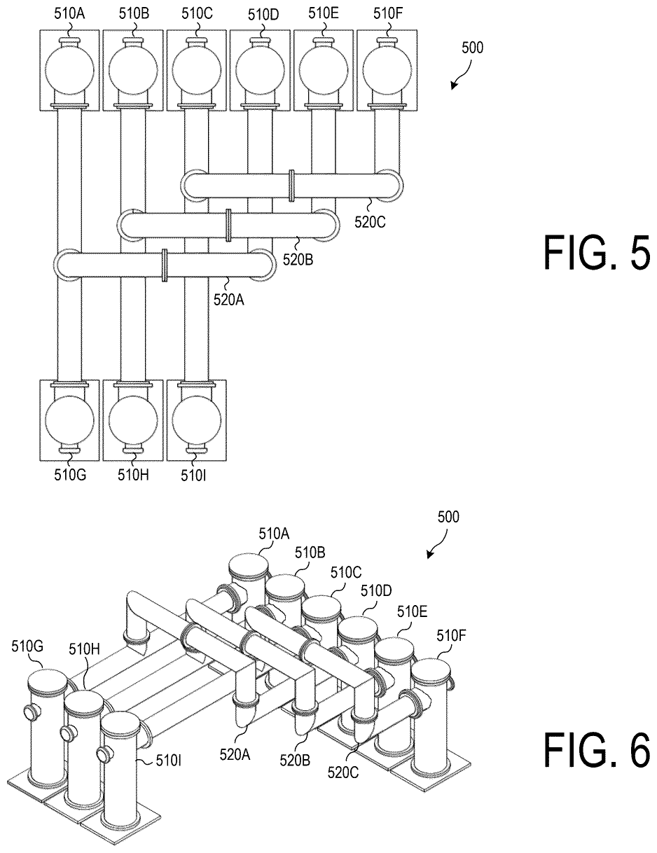

FIG. 5 is an overhead view of a three-phase, high-voltage cable splicing circuit 500 according to an exemplary device. FIG. 6 is a perspective view of the three-phase, high-voltage cable splicing circuit 500 from FIG. 5 according to an exemplary device. As shown in FIGS. 5 and 6, nine cable chambers 510A-510I (generally referred to as cable chambers 510) are provided. Three sets of three of these cable chambers 510 are connected by first, second, and third splicing chambers 520A, 520B, 520C (generally referred to as splicing chambers 520). In this way, FIGS. 5 and 6 illustrate a physical representation of three instances of the electrical configuration diagram of FIG. 1 placed side-by-side.

First, fourth, and seventh cable chambers 510A, 510D, 510G are connected through the first splicing chamber 520A. Second, fifth, and eighth cable chambers 510B, 510E, 510H are connected through the second splicing chamber 520B. Third, sixth, and ninth cable chambers 510C, 510F, 510I are connected through the third splicing chamber 520C.

The cable chambers 510 are each pipes configured to contain a high-voltage cable (not shown in FIGS. 5 and 6) that carries high-voltage current. The cable chambers 510 are each filled with an insulating gas to electrically insulate the high-voltage cables from corresponding walls of the cable chambers 510 the cable chambers 510 also may contain insulating supports to prevent the high-voltage cables from physically contacting corresponding walls of the cable chambers 510. In this way, the cable chambers operate comparable to the connecting gas compartments 320 in the device disclosed in FIG. 3.

The cable splicing chambers 520 are pipes that have three openings and connect to three separate cable chambers 510. The cable splicing chambers 520 are each filled with an insulating gas and each contain an electrical connection (not shown in FIGS. 5 and 6) configured to electrically connect the three high-voltage cables contained in the cable chambers 510 that connect to the cable splicing chamber 520. The electrical connection operates comparable to the electrical connection 360 in the device disclosed in FIG. 3 and is connected to the high-voltage cables in a manner similar to how the electrical connection 360 in the device disclosed in FIG. 3 connects to corresponding high-voltage cables 230.

In addition, each of the cable splicing chambers 520 includes an isolation circuit that allows the high-voltage cable contained in the corresponding cable splicing chamber 520 to be selectively disconnected from the electrical connection in the corresponding cable splicing chamber 520. In this way, individual high-voltage cables can be selectively connected and disconnected to the cable splicing circuit 500 without interfering with the operation of the other high-voltage cables connected to the same portion of the cable splicing circuit 500.

As shown in FIGS. 5 and 6, three sets of multiple cables can be separately spliced together in this configuration and any of the high-voltage cables can be selectively disconnected without affecting any of the other high-voltage cables. This configuration can represent a three-phase model of a high-voltage cable splicing circuit that can be used for connecting cables in a three-phase power system.

### Method of Operation

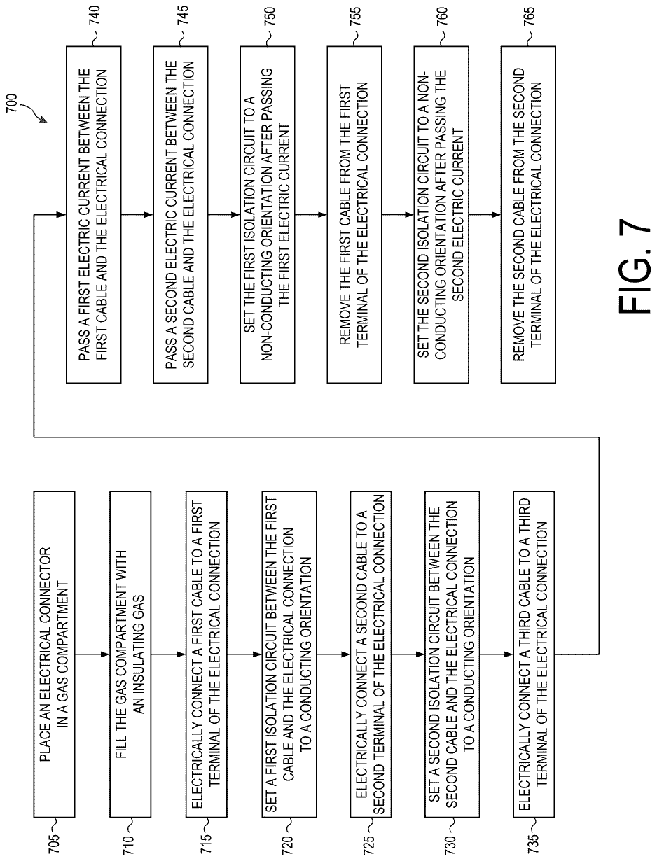

FIG. 7 is a flowchart 700 of a method of isolating a spliced high-voltage cable according to exemplary methods. As shown in FIG. 7 operation begins with step 710.

At step 705, a high-voltage electrical connection is placed in a gas compartment. This gas compartment is an airtight container such as a pipe, a box, or other suitable structure.

At step 710, the gas compartment is filled with an insulating gas. In various exemplary devices, the insulating gas may be sulfur hexafluoride (SF₆), which can serve as an effective electrical insulator. However, this is by way of example only. Other exemplary devices could use a different insulating gas that provides the desired level electrical insulation. For example, various fluorine-based gas mixtures, fluroketone-based gas mixtures, or dry air can be used as an insulating gas, though this list is not exhaustive. In some exemplary devices the insulating gas may be replaced with a vacuum to provide electrical insulation.

At step 715, a first high-voltage cable is electrically connected to a first terminal of the high-voltage electrical connection such that a first isolation circuit is arranged between the first high-voltage cable and the high-voltage electrical connection. This first isolation circuit could be a removable link, a switch, or any other suitable isolation circuit

At step 720, the first isolation circuit is set to a conducting orientation in which current is allowed to pass between the first high-voltage cable and the high-voltage electrical connection. For example, if the first isolation circuit is a removable link, this conducting orientation will be with the link inserted; and if the first isolation circuit is a switch, this conducting orientation will be with the switch closed.

At step 725, a second high-voltage cable is electrically connected to a second terminal of the high-voltage electrical connection.

At step 730, the second isolation circuit is set to a conducting orientation in which current is allowed to pass between the second high-voltage cable and the high-voltage electrical connection. For example, if the second isolation circuit is a removable link, this conducting orientation will be with the link inserted; and if the second isolation circuit is a switch, this conducting orientation will be with the switch closed.

At step 735, a third high-voltage cable is electrically connected to a third terminal of the electrical connection.

At step 740, a first electric current is passed between the first high-voltage cable and the high-voltage electrical connection.

At step 745, a second electric current is passed between the second high-voltage cable and the high-voltage electrical connection.

At step 750, after passing the first electric current between the first high-voltage cable and the high-voltage electrical connection, the first isolation circuit is set to a non-conducting orientation in which current is prevented from flowing between the first cable and the electrical connection. For example, if the first isolation circuit is a removable link, this non-conducting orientation will be with the link removed; and if the first isolation circuit is a switch, this non-conducting orientation will be with the switch open.

At step 755, the first high-voltage cable is removed from the first terminal of the high-voltage electrical connection. This allows the first high-voltage cable to be replaced, repaired, or whatever else needs to be done to it. While this is being done, the remainder of the high-voltage cables remain connected and operating normally and without interruption.

At step 760, after passing the second electric current between the second high-voltage cable and the high-voltage electrical connection, the second isolation circuit is set to a non-conducting orientation in which current is prevented from flowing between the second cable and the electrical connection. For example, if the second isolation circuit is a removable link, this non-conducting orientation will be with the link removed; and if the second isolation circuit is a switch, this non-conducting orientation will be with the switch open.

At step 765, the second high-voltage cable is removed from the second terminal of the high-voltage electrical connection. This allows the second high-voltage cable to be replaced, repaired, or whatever else needs to be done to it. While this is being done, the remainder of the high-voltage cables remain connected and operating normally and without interruption.

In alternate methods, additional high-voltage cables may be connected to a high-voltage electrical connection. In such case, the electrical connection would have to have a commensurate number of connection points.

Likewise, the method could include providing a third isolation circuit between the third high-voltage cable and the electrical connection, initially setting the third isolation circuit in a conducting orientation, later setting the third isolation circuit in a non-conducting orientation, and disconnecting the third high-voltage cable in a manner similar to how the first and second high-voltage cables are disconnected.

In addition, although FIG. 7 discloses a specific order of connecting the high-voltage cables and disconnecting the high-voltage cables, this is by way of example only. In alternate exemplary methods, first isolation circuit can be set to a non-conducting orientation (750) at any time during operation at which the first high-voltage cable needs to be isolated. Similarly, the second isolation circuit can be set to a non-conducting orientation (760) at any time during operation at which the second high-voltage cable needs to be isolated.

### Conclusion

This disclosure is intended to explain how to fashion and use various embodiments in accordance with the invention rather than to limit the true, intended, and fair scope and spirit thereof. The foregoing description is not intended to be exhaustive or to limit the invention to the precise form disclosed. Modifications or variations are possible in light of the above teachings. The embodiment(s) was chosen and described to provide the best illustration of the principles of the invention and its practical application, and to enable one of ordinary skill in the art to utilize the invention in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally, and equitably entitled. The various circuits described above can be implemented in discrete circuits or integrated circuits, as desired by implementation.

1. A high-voltage cable splicing circuit, comprising:
a gas compartment;
a first cable termination connected to the gas compartment;
a second cable termination connected to the gas compartment;
a third cable termination connected to the gas compartment;
an electrical connection located in the gas compartment and electrically connecting the first, second, and third cable terminations together;
a first isolation circuit located between the first cable termination and the electrical connection, the first isolation circuit being configured to selectively connect the first cable termination to the electrical connection and disconnect the first cable termination from the electrical connection; and
a second isolation circuit located between the second cable termination and the electrical connection, the second isolation circuit being configured to selectively connect the second cable termination to the electrical connection and disconnect the second cable termination from the electrical connection;
wherein the electrical connection does not directly contact a wall of the gas compartment.

2. The high-voltage cable splicing circuit of claim 1, wherein the gas compartment is filled with an insulating gas.

3. The high-voltage cable splicing circuit of claim 2, wherein the insulating gas is SF₆.

4. The high-voltage cable splicing circuit of claim 1, wherein the first and second isolating circuits are first and second switches, respectively.

5. The high-voltage cable splicing circuit of claim 1, wherein
the first isolation circuit comprises a first removable link,
the second isolation circuit comprises a second removable link,
the first isolation circuit is configured such that when the first removable link is inserted within the first isolation circuit the first cable termination is connected to the electrical connection, and when the first removable link is removed from the first isolation circuit the first cable termination is disconnected from the electrical connection, and
the second isolation circuit is configured such that when the second removable link is inserted within the second isolation circuit the second cable termination is connected to the electrical connection, and when the second removable link is removed from the second isolation circuit the second cable termination is disconnected from the electrical connection.

6. The high-voltage cable splicing circuit of claim 1, further comprising:
a third isolation circuit located between the third cable termination and the electrical connection, the third isolation circuit being configured to selectively connect the third cable termination to the electrical connection and disconnect the third cable termination from the electrical connection.

7. The high-voltage cable splicing circuit of claim 6, wherein
the third isolating circuit is a third switch.

8. The high-voltage cable splicing circuit of claim 6, wherein
the third isolation circuit comprises a third removable link, and
the third isolation circuit is configured such that when the third removable link is inserted within the third isolation circuit the third cable termination is connected to the electrical connection, and when the third removable link is removed from the third isolation circuit the third cable termination is disconnected from the electrical connection.

9. The high-voltage cable splicing circuit of claim 1, further comprising:
a plurality of electrical connection insulators configured to insulate the electrical connection from the wall of the gas compartment and prevent the electrical connection from contacting the wall of the gas compartment.

10. The high-voltage cable splicing circuit of claim 1, wherein
the gas compartment comprises one or more pipes.

11. The high-voltage cable splicing circuit of claim 1, wherein
the gas compartment further includes
a central gas compartment;
a first gas compartment connected between the central gas compartment and the first cable termination;
a second gas compartment connected between the central gas compartment and the second cable termination;
a third gas compartment connected between the central gas compartment and the third cable termination;
a first gas barrier formed between the central gas compartment and the first gas compartment;
a second gas barrier formed between the central gas compartment and the second gas compartment; and
a third gas barrier formed between the central gas compartment and the third gas compartment.

12. The high-voltage cable splicing circuit of claim 11, wherein
the first isolation circuit is formed in the first gas compartment,
the second isolation circuit is formed in the second gas compartment, and
the third isolation circuit is formed in the third gas compartment.

13. A high-voltage cable splicing circuit, comprising:
first, second, third, fourth, fifth, sixth, seventh, eighth, and ninth cable chambers;
first, second, and third cable splicing chambers;
wherein
the first cable splicing chamber is connected between the first cable chamber, the fourth cable chamber, and the seventh cable chamber,
the second cable splicing chamber is connected between the second cable chamber, the fifth cable chamber, and the eighth cable chamber,
the third cable splicing chamber is connected between the third cable chamber, the sixth cable chamber, and the ninth cable chamber, and
the first cable splicing chamber includes
a first electrical connection;
a first isolation circuit connected between the first electrical connection and the first cable chamber;
a fourth isolation circuit connected between the first electrical connection and the fourth cable chamber; and
a seventh isolation circuit connected between the first electrical connection and the seventh cable chamber.

14. The high-voltage cable splicing circuit of claim 13, wherein
each of the first, second, third, fourth, fifth, sixth, seventh, eighth, and ninth cable chambers and each of the first, second, and third cables splicing chambers is filled with an insulating gas.

15. The high-voltage cable splicing circuit of claim 13, wherein
the first, second, third, fourth, fifth, sixth, seventh, eighth, and ninth cable chambers contain first, second, third, fourth, fifth, sixth, seventh, eighth, and ninth high-voltage electrical cables, respectively.

16. The high-voltage cable splicing circuit of claim 13, wherein the second cable splicing chamber includes
a second electrical connection;
a second isolation circuit connected between the second electrical connection and the second cable chamber;
a fifth isolation circuit connected between the second electrical connection and the fifth cable chamber; and
an eighth isolation circuit connected between the second electrical connection and the eighth cable chamber.

17. The high-voltage cable splicing circuit of claim 16, wherein the third cable splicing chamber includes
a third electrical connection;
a third isolation circuit connected between the third electrical connection and the third cable chamber;
a sixth isolation circuit connected between the third electrical connection and the sixth cable chamber; and
a ninth isolation circuit connected between the third electrical connection and the ninth cable chamber.

18. A method of isolating a spliced high-voltage cable, comprising:
placing a high-voltage electrical connection in a gas compartment;
filling the gas compartment with an insulating gas;
electrically connecting a first high-voltage cable to a first terminal of the high-voltage electrical connection such that a first isolation circuit is arranged between the first high-voltage cable and the high-voltage electrical connection;
setting the first isolation circuit to a conducting orientation in which current is allowed to pass between the first high-voltage cable and the high-voltage electrical connection;
electrically connecting a second high-voltage cable to a second terminal of the high-voltage electrical connection;
electrically connecting a third high-voltage cable to a third terminal of the electrical connection;
passing a first electric current between the first high-voltage cable and the high-voltage electrical connection;
after passing the first electric current between the first high-voltage cable and the high-voltage electrical connection, setting the first isolation circuit to a non-conducting orientation in which current is prevented from flowing between the first cable and the electrical connection; and
removing the first high-voltage cable from the first terminal of the high-voltage electrical connection.

19. The method of claim 18, wherein
the operation of setting the first isolation circuit to the conducting orientation includes placing a first link between the first high-voltage cable and the high-voltage electrical connection, and
the operation of setting the first isolation circuit to the non-conducting orientation includes removing the first link from between the first high-voltage cable and the high-voltage electrical connection.

20. The method of claim 18, wherein
the operation of setting the first isolation circuit to the conducting orientation includes causing a first switch located between the first high-voltage cable and the high-voltage electrical connection to be placed in a closed position that allows current to flow through the first switch, and
the operation of setting the first isolation circuit to the non-conducting orientation includes causing the first switch to be placed in an open position that prevents current from flowing through the first switch.
